(19) United States
(12) Patent Application Publication
(10) Pub. No.: US 2010/0279659 A1
(43) Pub. Date: Nov. 4, 2010

(54) WEB-ENABLED ELECTRONIC VIDEO MAIL SYSTEM FOR USE WITH MOBILE PHONES AND OTHER HANDHELD ELECTRONIC DEVICES

(76) Inventor: Dwarakinath Harish, Duluth, GA (US)

Correspondence Address: Woodcock Washburn LLP, 2929 Arch Street, Philadelphia, PA, 19104, US

(21) Appl. No.: 12/580,232

(22) Filed: Oct. 15, 2009

Related U.S. Application Data
(60) Provisional application No. 61/214,873, filed on Apr. 29, 2009.

(51) Int. Cl. H04W 4/12

(52) U.S. Cl. 455/412.1

(57) ABSTRACT

A web-enabled electronic video mail system for use with mobile phones and other handheld electronic devices, wherein video messages will be compressed and stored on a video mail website/server and can be accessed by selected mobile devices instantaneously, wherein MPEG-4 or H.264 formats are the preferred file transfer formats thus facilitating quicker transfers and reduced server storage space.

### PRIORITY CLAIM

The present non-provisional patent application hereby claims priority to U.S. provisional patent application No. 61/214,873 entitled WEB-ENABLED ELECTRONIC VIDEO MAIL SYSTEM FOR USE WITH MOBILE PHONES AND OTHER HANDHELD ELECTRONIC DEVICES filed on Apr. 29, 2009.

### TECHNICAL FIELD

The present invention relates generally to mobile phones and electronic transmissions, and more specifically to web-enabled electronic video mail system for use with mobile phones and other handheld electronic devices.

### BACKGROUND

Having the ability for instantaneous communication has become critical in our modern society. Due to the advances in technology, we are now able to receive emails and text messages almost instantly on our mobile handheld devices. However, these forms of communication have many disadvantages. For instance, many individuals attempting to text or email on their mobile phone get frustrated with the time and effort it takes to type the text of the message. As a result, many users use abbreviations and acronyms in lieu of proper grammar. Consequently, it is understood how these advances in technology have adversely affected people's ability to type proper grammar. Moreover, many users attempt to text or email while driving, thus, causing many accidents and injuries. A multitude of States are considering laws that would make it illegal to text or email while driving a motor vehicle.

In addition, many people can only text at about a 30-60 word per minute rate. As a result, only a minimum amount of information can be effectively conveyed. Thus, text messages and emails can be misinterpreted as the user may read too much or too little into the “tone” of the text/email. Moreover, any amount of words can not convey what a picture, and more specifically, a video can convey.

The present invention solves these deficiencies by providing a web-enabled electronic video mail system for use with mobile devices. Many advantages will be realized by such a system such as, for exemplary purposes only, family and friends will be enabled to see each other while communicating thus adding a personal touch to messages; people can watch a video of products they are interested in, rather than going to the showroom in order to get an impression (i.e. cars, furniture, houses); experts can provide better customer service and troubleshooting by seeing a video clip of the problem in order to fix it faster, rather than spending hours on the phone or in front of the computer; airtime can be reduced thus reducing telephone costs; and teachers will be able to send short clips to students of educational materials.

Therefore, it is readily apparent that there is a need for a video messaging system that can work with mobile phones and other mobile devices to 1) reduce the incidents of accidents; 2) provide greater detail of the message intended to be conveyed; 3) reduce the inefficiencies associated with typing; 4) provide a more personalized communication means; and 5) to facilitate the use of video communication in trouble shooting and education environments.

### BRIEF DESCRIPTION

The present invention overcomes the above-mentioned disadvantages and meets the recognized need for such a system by providing a web-enabled electronic video mail system for use with mobile phones and other handheld electronic devices. Briefly described, video messages will be stored on a video mail website/server and can be accessed by mobile phones instantaneously. Mobile devices will be equipped with a new video message prompt, which when clicked, directs the user to the video mail website/server wherein he can access his new video message and instantly reply thereto via video.

### BRIEF DESCRIPTION OF THE DRAWINGS

The present invention will be better understood by reading the Detailed Description with reference to the accompanying drawing figure, in which:

FIG. 1 is a general diagram showing the data communications components of a preferred embodiment of the video mail delivery system.

FIG. 2 is an example of actual packaging of the video and transmission for the system of FIG. 1; and

FIG. 3 is an illustration of data communication connections to a video media gateway and media server.

FIG. 4 is a detailed illustration of the unpacking of the video for display on the receivers end.

### DETAILED DESCRIPTION OF THE PREFERRED AND SELECTED ALTERNATIVE EMBODIMENTS

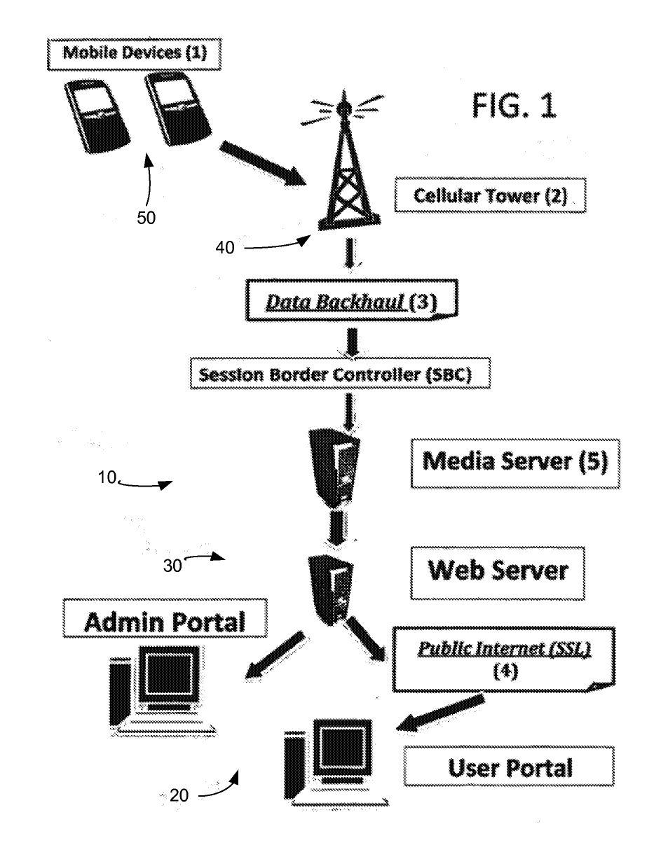

In describing the preferred and selected alternate embodiments of the present invention, as illustrated in FIGS. 1-4, specific terminology is employed for the sake of clarity. The invention is not, however, intended to be limited to the specific terminology so selected, and it is to be understood that each specific element includes all technical equivalents that operate in a similar manner to accomplish similar functions.

Referring now to FIGS. 1-4, the present invention 10 in a preferred embodiment, broadly described is a web-enabled electronic video mail system for use with mobile phones and other handheld electronic devices. System 10, generally comprises: computers 20, server 30, wireless transmission and receiving subsystem 40, and mobile devices 50.

Server 30 is an electronic storage medium in communication with computers 20 and mobile devices 50, wherein server 30 stores user information and preferences, and wherein server 30 stores video transmitted to and from selected mobile devices 50. More specifically, a user can, via a computer 20 or a mobile device 50, set up an account and password on the server 30 that is specific to that user. Once signed on, the user can automatically download a media player software specific for this application. After setup, the user can record a video message on his mobile device 50, and wirelessly transmit said video (or in an alternative embodiment, access the server via computer 50) to receiving subsystem 40, wherein said video is then transmitted to server 30, and wherein the intended recipient(s) is immediately notified that he has video mail. The intended recipient(s) can then access said server (whether or not said intended receiver(s) has video capabilities with his service provider) and play the video message. He can then respond to said video message via his own video message wherein the original sender will be immediately notified and thus can immediately access the video mail response.

Out of 1 billion camera phones shipped in 2008, smartphones, the higher end of the market with full email support, represent about 10% of the market or about 100 million units. The present video mail invention could be used in over a billion smartphones all over the world in 2-4 yrs, with highest growth in Asian, European, South American sector look at Globalization.

To facilitate use of the system 10 by all mobile device owners (not specific to a particular service provider), each video mail user, irrespective of his type of mobile device 50 (or computer 20 if accessing not via his mobile device 50), will receive a unique video mail ID (and password) such that he will have access to server 30. Each mobile device 50 can store said ID and password such that the user can simply click an icon on his mobile device 50 to have instant access to the video mail server 30.

The mobile device 50, as with most phones, will have to have video camera capabilities or be adaptable to incorporate same. In addition, the mobile device 50 will need a media player, which once the user signs on to the video mail server 30, a video player software can automatically be downloaded to said mobile device 50. In use, the user can click a video mail icon on their web enabled phone which will enable and activate the video capturing means on his mobile device 50. The user can then capture a video no differently than recording a regular video. The message can be played back before it is sent. If the user is not satisfied, they can rerecord the message. Next, the message is ready to be sent. Then, a prompt is displayed, asking for the phone number or video mail ID of the recipient. The mobile device 50 then sends the video to the server 30 and notifies the recipient of the video message. The recipient can similarly respond.

Now referring to FIGS. 1-4 in greater detail, the preferred embodiment comprises:

### Video Format

The video mail invention will utilize existing media types to capture and encode the raw video, including but not limited to, MPEG-2, MPEG-4, H.263, H.264, WMV. The method for sending these videos will be one of the following: Email, IM or MMS. MPEG-4 transmits at 85 Kb/s and H.264 transmits at 50 Kb/s. MPEG-4 requires approximately one-third of the bandwidth and H.264 requires just one-fifth. With better compression, stored files will take up much less room on a server—hence potentially saving significantly sums in network storage requirements in addition to expediting the video transfer.

### Mobile GUI Control Interface

Software will preferably reside on the cellular or mobile device and will be activated by the use of an icon on the mail viewing area of the device which will be easily recognizable and accessible to the user. This icon will allow a quick launch of the application. In addition, the arrival of new video mails to the application will be announced by a smart ring which may be set by the user. A text notification will also allow the user to choose to receive, ignore or access the video mail area within the application to view all video mails.

### Mobile Application Functions

Once launched, the mobile application will be a complete GUI interface for the user to capture, notate and send videos. With the mobile application launched, the user will be able to select videos taken from the standard phone video interface and preview them for sending. The user will then be preferably asked to notate the video with title, author and description type information. Finally the user will click the button to encrypt and send. This will package the video into an encrypted file for sending wherein the receiver will preferably need to open in the same application.

### Video Notating or Tagging

Once created the user may package videos with information tags to be included in the total video package. Tagging video messages may include, but are not limited to, a text string for the following: video title, subtitle, author, date hexadecimal encryption for security, and notes about the video.

### Video Mail Platform Overview

The present invention includes a mobile device client application and a server side application. The server side application will include a media server application which manages the video media. In addition, there will be a media gateway which regulates the incoming and outgoing flow of video media packages from sender to media server and finally to recipient. Their will be embedded email, MMS and IM server application in the media software which will utilize Email, MMS and IM protocols respectively to transport video media packages to and from users upon availability.

When utilizing MMS it may be necessary to work with telecommunications carriers, the MMS and other regulatory bodies and VARs for the transportation of messages to and from cellular devices through SS7 gateways.

### Online Portal Overview

As a part of the preferred embodiment of the present invention, an organizational portal will be created in the following manner to support the video package content as follows. There will be an administration server utilizing a database and html based programming language such as .NET or .PHP to create an online portal for the management of video content storage. This portal will support parent child relationship, hierarchies and tracking for reporting purposes. In addition there will be Email and other mail program tie-ins and abuse reporting functionality.

### User Portal Functionality

All video mail users will be able to login to an online portal where they can view, add, edit and manage their videos. Users will be assigned a unique username and password so they may access only their video area. The portal will be SSL encrypted for security. Users may also be allowed to give access to friends or business users so that they may view folders of videos and have limited access to add, edit, and delete functionalities. In addition, both main user and sub users (friends etc) may be able to add notation to videos in a blog-like fashion for commenting and collaboration.

### Admin Portal Functionality

The present invention will also include an administration portal built on the same database with additional functions and features allowing the administrator users to add, edit and delete users; manage user content for abuse and other cases; generate sales reporting documents; and manage merchant accounts.

The preferred method for capturing and sending video is executed per transmission using the following steps:
a) Start-Up Application—A sender will utilize the device specific existing embedded video mail software by clicking the new Video Mail icon provided on the main screen or other similar method depending on device.
b) Video Capture—The application will open and ask the sender to either capture a new video or browse and attach an existing video. Depending on the device and SDK methods available, some users may need to first take the video using the devices on-board video capture functions and save it to the device, then browse to the video from the Video Mail application. Some users may be able to simply open the Video Mail application and capture new video from within the Video Mail capture screen and immediately notate, package and send.
c) Video Wrapper—No matter which method is employed, the sender will preferably need to use the on-board video camera to take a new video before either saving or sending. The Video Mail application is a wrapper shell which would reside on the device and take advantage of the device's existing video capture functions when possible.
d) Video Notation—Once the video has been selected via the Video Mail interface, the user will be given the option to add information to the video before sending the enclosed video packet. Information may include, but is not limited to, the following:

Name, Title, Author, Date, Notes, Password, Encryption.
e) Video File Creation—The Video Mail software will then pack up the video and the enclosed information into a single file package to send via email or IMS to another device. One method which may be used would utilize a set of MPEG type optimized libraries and software from Georgia Tech, or a number of libraries for FFT, MPEG, compression, and encryption. In addition, it may also include encryption acceleration patches for usage on the Cell Broadband Engine processor.
f) Video Sending—The sender will then utilize the GUI interface in the Video Mail mobile application to send the video mail package which will record the sending of the file on-board in a mobile data file if possible and send the file to the video mail media server via IP data services.
g) Video Network—The video packet will then travel from the device over the existing carrier's data network to the Video Mail media server SBC gateway for entry into the video media server library. A method of reply will announce back to the mobile device a successful transfer and the time and date of transfer to the server will be recorded on the device via the on-board data file structure if possible.
h) Video Media Server—The video media server will accept the package and a media gateway and reply with a success notice to the mobile device. An http server will negotiate the routing of the media packet to the recipient in the form of an email or IMS with attached video packet.
i) Video Package Receiving—The Video Mail package will then be delivered to the mobile phone receiver. In the preferred embodiment, the mobile device which receives this video package will need to have the Video Mail software installed in order to open the package. The user will receive the Video Mail message and click on a link to open the file. This will automatically open the Video Mail software which will allow the user to view the file and its notations. The user can then use the Video Mail software to store the file on the device in a folder structure which the user can define from within the Video Mail application. If the receiver does not already have the Video Mail software, the video mail email or IMS will prompt the user to click on a link to download the software.

### Video Mail Methodology

The present invention provides a video mail transmission over data networks, defined as a transmission of video embedded inside a package which carries a component in the form of text information notes. The managing media server and gateway will assume all control over the transmission through the data network and report the particulars of the transmission through the client software, including the transmission time/receipt time, to the sender and receiver, and, if requested, encrypt and password protect, for the privacy of sender and receivers of the message.

### Transmit Ion Scheduling

Each video transmission request is scheduled for transmission by the managing media server gateway platform, and the video transmission itself will not be manipulated during transmission by all involved telephone and/or computer networks. This imparts a level of security on a per transmission basis to the managing media server which may use any data network, local and interurban inter-exchanges, along with fiber optic and coaxial, satellite, analog RF and digital wireless communications infrastructure. To realize the most efficient transmission path for the video mail message. The managing media server will transport the message through a digital protocol format, video package, and compress/decompress the message at end points on the transmission path,

If the receiver is unavailable it will temporarily store the video in the email on the media server and eliminate the need for the sender-receiver to permanently engage a network provider for a dedicated send point to receiver point broadband channel to any of several video mail receivers.

FIG. 1 illustrates an example of how the data communications components of the video mail delivery system and the video packages will transfer over the mobile network infrastructure. In this diagram, the mobile phone or device 1 communicates with the cellular tower 2 which communicates with the backhaul infrastructure 3 and the public Internet 4 which then allows communication with the media server systems 5.

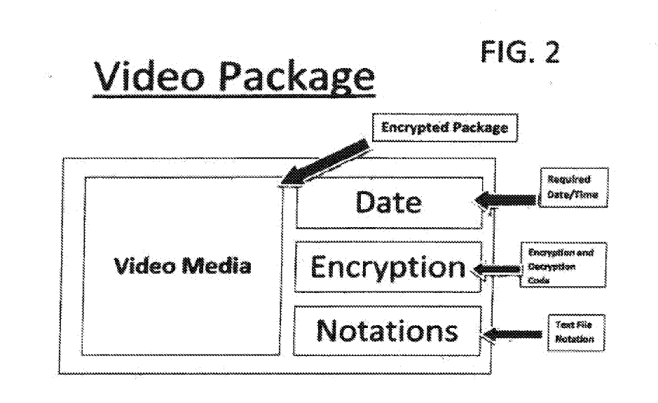

FIG. 2 illustrates the video media gateway 1 which is directly controlled by an operator of the managing media server and video mail provider. The media gateway 1 similar to a router with a video signal interface, takes in media packages and the video gateway encoders 2 which can provide encryption on both incoming and outgoing packages if needed. The media is then sent to the media server 3 for hosting and from there can be served upon demand and/or request to the user by the communication manager 4 to the video media gateway 1.
Note: A transcoder could be included for management of varying picture quality, or varying bandwidth transmission, like High Speed Digital Subscriber Lines (HSDLs).

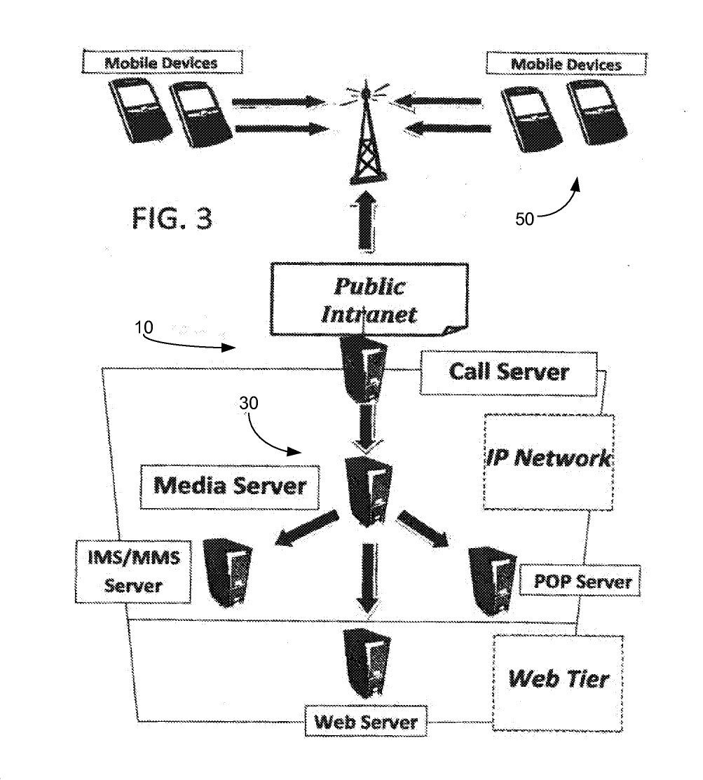

FIG. 3 illustrates the video media gateway sending the video from the media server upon request through the video gateway encoders and by way of the communication, manages the back haul utilizing the embedded email pop, IMS or MMS servers. The video media packages are then transported from the backhaul to the towers for the cellular data network and to the end user on their mobile device.

The mobile data network architecture for this example system may be provided by a private network control system, satellite or cable network facilities, or it may be provided by an MVNO or MNO service the sender and/or receiver have subscribed to. This data connection is needed in the preferred embodiment in order to provide a physical telecommunication link between a sender and a receiver.

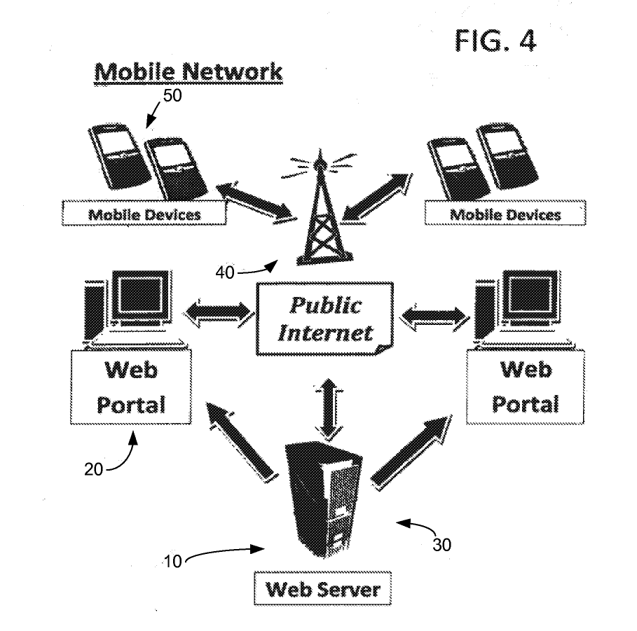

FIG. 4 illustrates the steps of sender/managing portal interaction which allows for video management control. This interaction is initiated by the sender who may invite receiver or viewers to a subscriber through a telephone, or computer system. The sender/video manager may utilize this system to view, add, edit or delete video email packages. The sender may specify the receivers and desired encryption, along with the format, size and quality to be stored and sent based on data rates or formats. The administration portal may then prompt users for reporting parameters so that the sender may receive a documented notice of video mail receipt for legal or other business purposes.

### Additional Considerations:

The current system is different from MMS and IMS. Multimedia content created by one brand of MMS phone may not be entirely compatible with the capabilities of the recipients' MMS phone. MMS requires a number of handset parameters to be set. Poor handset configuration is often blamed as the first point of failure for many users. Additionally, service settings are sometimes preconfigured on the handset. Although the typical standard does not specify a maximum size for a message, 300 kB is the current recommended size used by networks due to some limitations on the WAP gateway. MPEG-4 transmits at 85 Kb/s and H.264 transmits at 50 Kb/s. MPEG-4 requires approximately one-third of the bandwidth and H.264 requires just one-fifth. With better compression, stored files will take up much less room on a server—hence potentially saving significantly sums in network storage requirements.

Having thus described the preferred and exemplary alternate embodiments of the present invention, it should be noted by those skilled in the art that the foregoing disclosures are exemplary only, and that various other alternatives, adaptations, and modifications may be made within the scope of the present version of the invention. Accordingly, the present version of the invention is not limited to the specific embodiments illustrated herein, but is limited only by the following claims.

What is claimed is a:

1. A web-enabled electronic video mail system for use with mobile phones and other handheld electronic devices, comprising:
at least one server having means for storing selected user information and video mail;
at least one wireless transmission and receiving means in communication with said at least one server; and
at least one mobile device capable of capturing and transmitting video, wherein said captured video can be compressed and transmitted to said server and wherein another user can access said server to obtain said video mail.

2. A video mail system, comprising:
means for user interface;
means for capturing a video;
means for video notation;
means for compressing said video;
means for sending said video;
means for receiving said video and saving said video; and
means for retransmitting said video to another device.
